(19) United States
(12) Patent Application Publication
(10) Pub. No.: US 2019/0022757 A1
(43) Pub. Date: Jan. 24, 2019

(54) LINKAGE OF COMPOSITE CORE FEATURES

(71) Applicant: United Technologies Corporation, Farmington, CT (US)

(72) Inventor: John J. Marcin, Marlborough, CT (US)

(21) Appl. No.: 15/654,174

(22) Filed: Jul. 19, 2017

(51) Int. Cl. B22F 5/04; F01D 25/00; B22F 3/22

(52) U.S. Cl. CPC B22F 5/04; F01D 25/005; B22F 3/225; F05D 2220/32; F05D 2230/22; F05D 2240/12; F05D 2300/603; F05D 2300/13; F05D 2240/30

(57) ABSTRACT

Aspects of the disclosure are directed to a method comprising obtaining a refractory metal core (RMC), installing the RMC inside a tool, and subsequent to installing the RMC inside the tool, injecting a slurry into the tool to form a composite body from the RMC and the slurry. Aspects of the disclosure are directed to a composite body, comprising: a refractory metal core (RMC), and a slurry that at least partially encapsulates the RMC.

### BACKGROUND

Gas turbine engines, such as those which power aircraft and industrial equipment, employ a compressor to compress air that is drawn into the engine and a turbine to capture energy associated with the combustion of a fuel-air mixture. Components of the engine, such as for example turbine blades of the turbine, are frequently manufactured using an investment casting technique. In investment casting, passages are produced by pre-fabricating ceramic cores that represent positive replica of the passages. The cores are assembled together and placed in an injection die to create wax patterns with the ceramic embedded therein. These patterns are then assembled as part of a cluster to create a hollow ceramic shell. The wax is then removed (e.g., melted) from the interior of the shell, leaving the ceramic cores locked inside. After preparation of the ceramic shell, molten metal is cast in the ceramic shell and solidified. The ceramic shell is removed (e.g., mechanically removed) from the cluster of cast metal parts and the ceramic cores are removed (e.g., chemically removed), thereby creating the passages.

As features (e.g., the aforementioned passages) of the components become more complex in terms of, e.g., shape or dimension, the investment casting technique described above becomes less effective due to the fragile nature of the ceramic cores. Refractory metals may be used to make the cores. These refractory metal cores (RMCs) enable features of greater complexity to be fabricated (relative to the use of ceramic cores) due to higher strength when possessing intricate, fine features. RMCs are typically fabricated by punching, stamping, or laser drilling details into sheet metal. The RMCs can be used as the core itself or combined with ceramic cores to produce multiwall castings. While effective, RMCs tend to be expensive, thereby serving as a significant limitation to their applicability/use.

Another technique for fabricating metal and ceramic parts is known in the art as TOMO photolithography. Referring to FIGS. 3A-3B, as part of a first step of TOMO photolithography, laminated sheets 302 of Copper-Beryllium (Cu—Be) are created by photolithography and are stacked in a production tool 308 to make a master pattern of a core shape. As shown in FIG. 3C, a silicone mold 314 is then created from this master pattern. In many instances, the mold 314 is divided into two halves 314a and 314b that are secured to respective backing plates 320a and 320b (see FIG. 3D). The plates 320a and 320b add rigidity to the mold 314a/314b. The plates 320a and 320b are then joined (e.g., mechanically joined) to one another in mated assembly (see FIG. 3E) to produce a cavity between the mold halves 320a and 320b into which a ceramic slurry is poured and hardened with an epoxy binder. When the slurry hardens/sets, the plates 320a and 320b are separated from one another and the ceramic is strong enough to be removed from the mold 320a/320b without breaking to produce a ceramic core 332 (see FIG. 3F) with complex features not normally producible via the techniques described above. The epoxy binder can then be removed (e.g., chemically or thermally) before the ceramic core 332 is heated/fired to harden the ceramic core 332. The ceramic core 332 can then be used as part of the investment casting technique to produce single walled components (multi-walled components/cavities are not producible using this technique). However, the ceramic core 332 produced via TOMO photolithography is still relatively fragile, such that a limit is reached as features of the components become more complex.

A variant of the TOMO photolithographic technique described above entails pouring a metal/epoxy slurry into the silicone mold to produce metal components; the epoxy binder is typically not removed. Tungsten CT scan filters are one type of component/object that is produced using this variant.

Given current trends toward component features of increasing complexity, what is needed is an improved ability to fabricate such features.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure are directed to a method comprising: obtaining a refractory metal core (RMC), installing the RMC inside a tool, and subsequent to installing the RMC inside the tool, injecting a slurry into the tool to form a composite body from the RMC and the slurry. In some embodiments, the method further comprises removing the composite body from the tool, and sintering the composite body subsequent to removing the composite body from the tool. In some embodiments, the slurry includes a binder. In some embodiments, the binder includes at least one of a mixture of soluble wax and epoxy or colloidal silica. In some embodiments, the method further comprises removing the binder from the composite body to obtain a binder-free composite body. In some embodiments, the method further comprises sintering the binder-free composite body. In some embodiments, the removal of the binder is performed via an application of one or more chemicals. In some embodiments, the removal of the binder is performed by heating the binder. In some embodiments, the RMC includes at least one of molybdenum, tungsten, tantalum, or niobium. In some embodiments, the method further comprises fabricating the RMC using at least one of: stamping, laser cutting, application of a photolithography technique, or application of an additive manufacturing technique. In some embodiments, the method further comprises closing the tool prior to injecting the slurry into the tool. In some embodiments, the tool includes a mold arranged as two halves, a first of the two halves secured to a first plate and a second of the two halves secured to a second plate, and closing the tool includes joining the plates to one another in mated assembly. In some embodiments, the method further comprises installing the composite body into a die. In some embodiments, the method further comprises injecting molten material into the die to form a component, where the composite body forms at least one of a hole or a passage in the component. In some embodiments, the method further comprises injecting molten material into the die to form at least one pattern, assembling the at least one pattern onto a fixture, dipping the fixture into a ceramic media to create a mold, removing wax from inside of the mold, melting metal and pouring the melted metal into the mold, and removing the mold when the melted metal solidifies. In some embodiments, the method further comprises firing the mold prior to pouring the melted metal into the mold. In some embodiments, the RMC includes at least one attachment feature for encapsulating and locking the slurry to the RMC. In some embodiments, the at least one attachment feature includes at least one of: a semi-spherical bump, a slot, a pin, a through-pin, an indentation, or a tapered edge.

Aspects of the disclosure are directed to a composite body, comprising: a refractory metal core (RMC), and a slurry that at least partially encapsulates the RMC. In some embodiments, the slurry includes at least one of a ceramic material or metal material, the slurry includes a binder, and the RMC includes at least one attachment feature to lock the slurry to the RMC.

### BRIEF DESCRIPTION OF THE DRAWINGS

The present disclosure is illustrated by way of example and not limited in the accompanying figures in which like reference numerals indicate similar elements. The drawing figures are not necessarily drawn to scale unless specifically indicated otherwise.

FIG. 1 is a side cutaway illustration of a geared turbine engine.

FIGS. 2-2A illustrate flow charts of methods for manufacturing a component in accordance with aspects of this disclosure.

FIGS. 3A-3F illustrate a tool set that is used to form a ceramic core in accordance with the prior art.

FIGS. 4A-4H illustrate a sequence used to fabricate a component from a composite material in accordance with aspects of this disclosure.

FIGS. 5A-5F illustrate attachment features of refractory metal cores in accordance with aspects of this disclosure.

### DETAILED DESCRIPTION

It is noted that various connections are set forth between elements in the following description and in the drawings (the contents of which are incorporated in this specification by way of reference). It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities or a space/gap between the entities that are being coupled to one another.

As described further below, aspects of this disclosure may be used to address weaknesses/deficiencies associated with conventional manufacturing techniques. For example, aspects of the disclosure may be used to address the fragility of ceramics that have been used in the manufacture of multi-wall passages of a component.

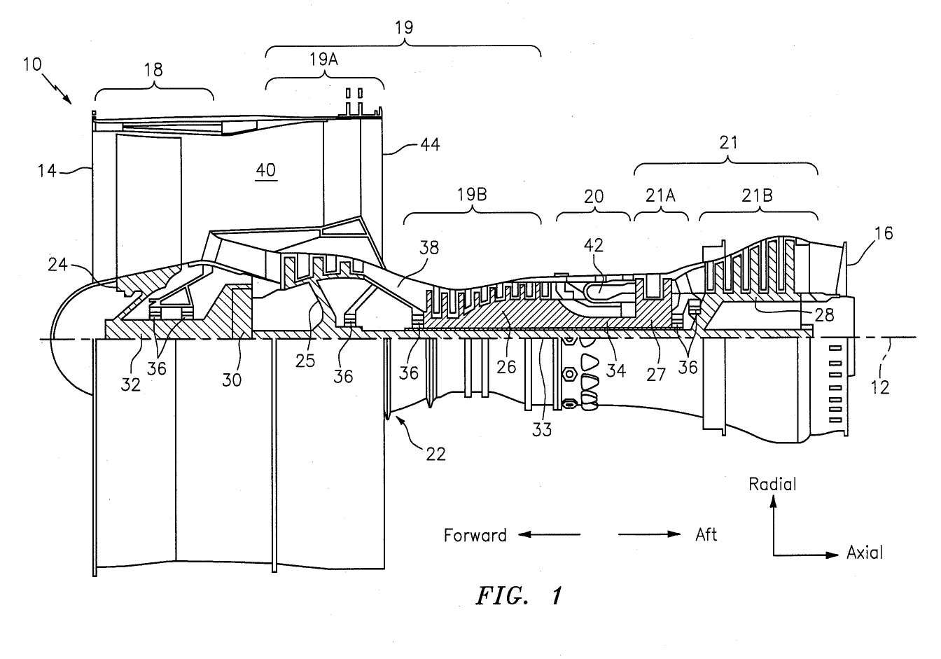

Aspects of the disclosure may be applied in connection with a gas turbine engine. FIG. 1 is a side cutaway illustration of a geared turbine engine 10. This turbine engine 10 extends along an axial centerline 12 between an upstream airflow inlet 14 and a downstream airflow exhaust 16. The turbine engine 10 includes a fan section 18, a compressor section 19, a combustor section 20 and a turbine section 21. The compressor section 19 includes a low pressure compressor (LPC) section 19A and a high pressure compressor (HPC) section 19B. The turbine section 21 includes a high pressure turbine (HPT) section 21A and a low pressure turbine (LPT) section 21B.

The engine sections 18-21 are arranged sequentially along the centerline 12 within an engine housing 22. Each of the engine sections 18-19B, 21A and 21B includes a respective rotor 24-28. Each of these rotors 24-28 includes a plurality of rotor blades arranged circumferentially around and connected to one or more respective rotor disks. The rotor blades, for example, may be formed integral with or mechanically fastened, welded, brazed, adhered and/or otherwise attached to the respective rotor disk(s).

The fan rotor 24 is connected to a gear train 30, for example, through a fan shaft 32. The gear train 30 and the LPC rotor 25 are connected to and driven by the LPT rotor 28 through a low speed shaft 33. The HPC rotor 26 is connected to and driven by the HPT rotor 27 through a high speed shaft 34. The shafts 32-34 are rotatably supported by a plurality of bearings 36; e.g., rolling element and/or thrust bearings. Each of these bearings 36 is connected to the engine housing 22 by at least one stationary structure such as, for example, an annular support strut.

As one skilled in the art would appreciate, in some embodiments a fan drive gear system (FDGS), which may be incorporated as part of the gear train 30, may be used to separate the rotation of the fan rotor 24 from the rotation of the rotor 25 of the low pressure compressor section 19A and the rotor 28 of the low pressure turbine section 21B. For example, such an FDGS may allow the fan rotor 24 to rotate at a different (e.g., slower) speed relative to the rotors 25 and 28.

During operation, air enters the turbine engine 10 through the airflow inlet 14, and is directed through the fan section 18 and into a core gas path 38 and a bypass gas path 40. The air within the core gas path 38 may be referred to as “core air”. The air within the bypass gas path 40 may be referred to as “bypass air”. The core air is directed through the engine sections 19-21, and exits the turbine engine 10 through the airflow exhaust 16 to provide forward engine thrust. Within the combustor section 20, fuel is injected into a combustion chamber 42 and mixed with compressed core air. This fuel-core air mixture is ignited to power the turbine engine 10. The bypass air is directed through the bypass gas path 40 and out of the turbine engine 10 through a bypass nozzle 44 to provide additional forward engine thrust. This additional forward engine thrust may account for a majority (e.g., more than 70 percent) of total engine thrust. Alternatively, at least some of the bypass air may be directed out of the turbine engine 10 through a thrust reverser to provide reverse engine thrust.

FIG. 1 represents one possible configuration for an engine 10. Aspects of the disclosure may be applied in connection with other environments, including additional configurations for gas turbine engines. Aspects of the disclosure may be applied in connection with non-geared engines.

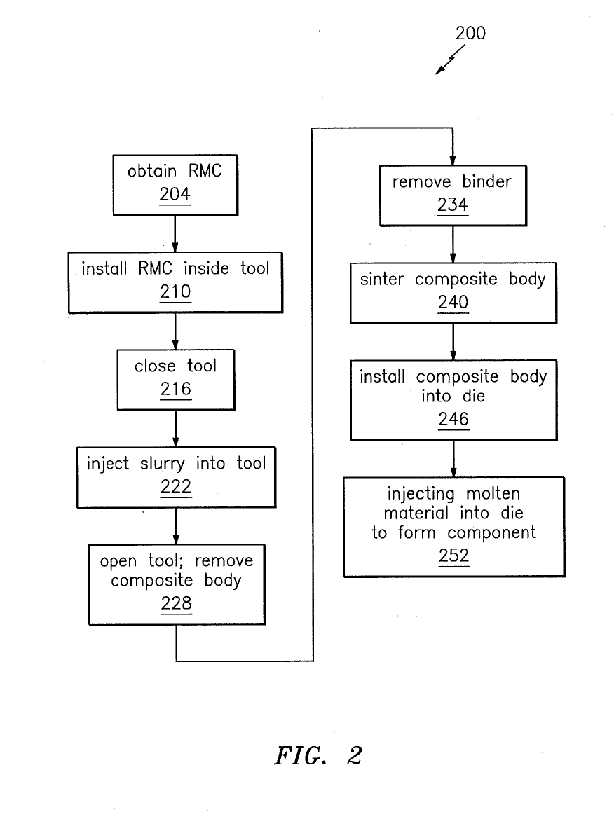

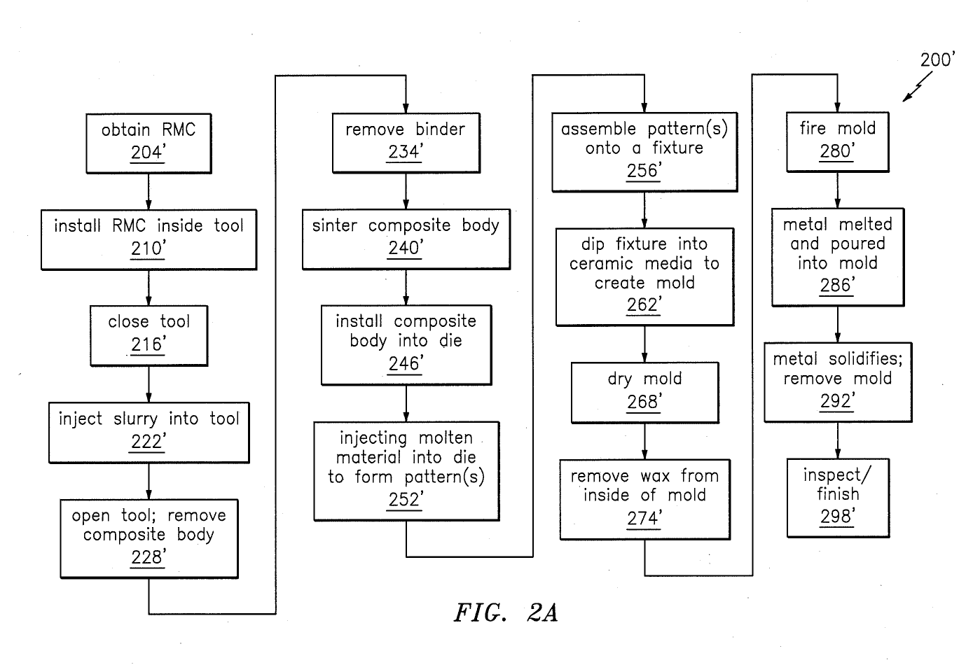

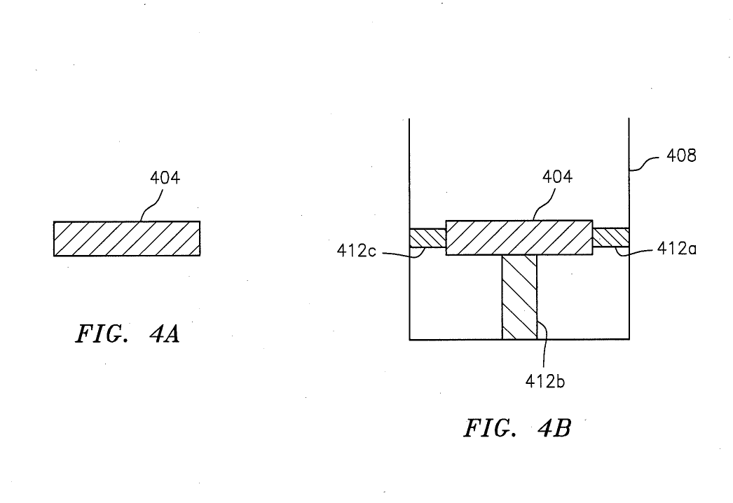

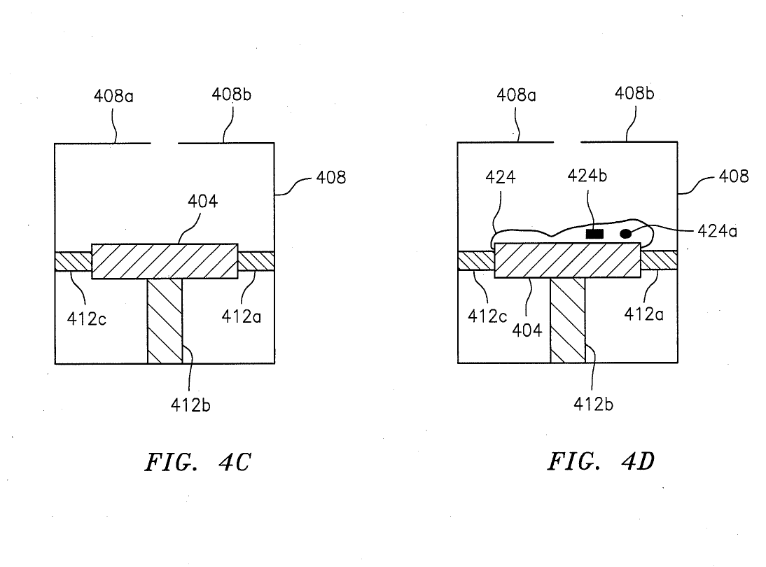

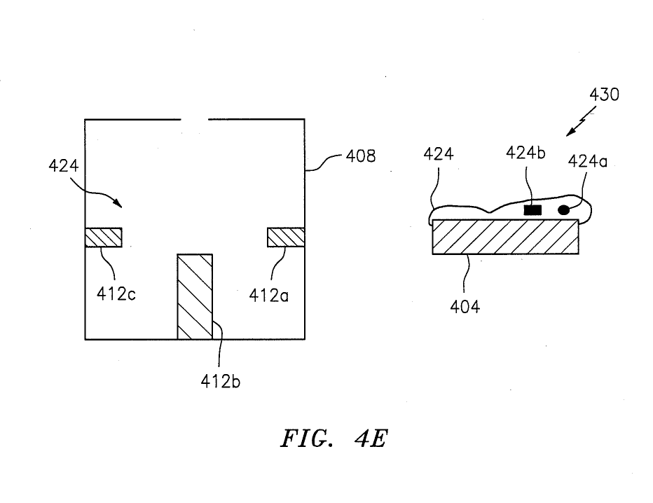

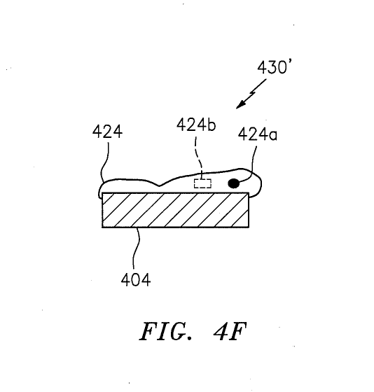

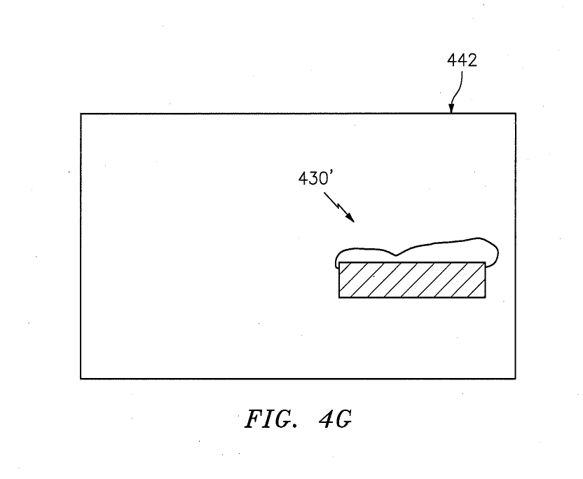

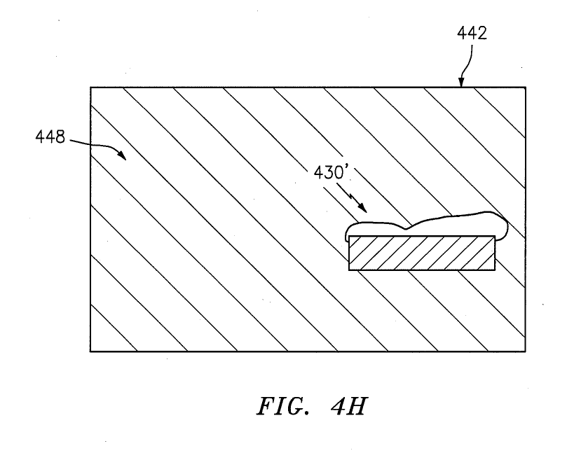

Referring to FIG. 2, a flow chart of an exemplary method 200 is shown. The method 200 may be used to fabricate a component, such as for example a component of the engine 10 of FIG. 1. The component that is fabricated may include a vane or a blade of the engine 10, such as for example a vane or a blade of the fan section 18, the compressor section 19, or the turbine section 21. The method 200 is described below in relation to the structures shown in FIGS. 4A-4H. The method 200 may be adapted to accommodate other forms/types of structures.

In block 204, a refractory metal core (RMC) 404 (see FIG. 4A) may be obtained. The RMC 404 may include one or more materials/elements, such as for example molybdenum, tungsten, tantalum, niobium, etc. As part of block 204, the RMC 404 may be fabricated by using one or more techniques, such as for example stamping, laser cutting, applying TOMO photolithography, or via additive manufacturing (e.g., direct metal deposition, laser sintering, photopolymerization, ink jet printing, etc.).

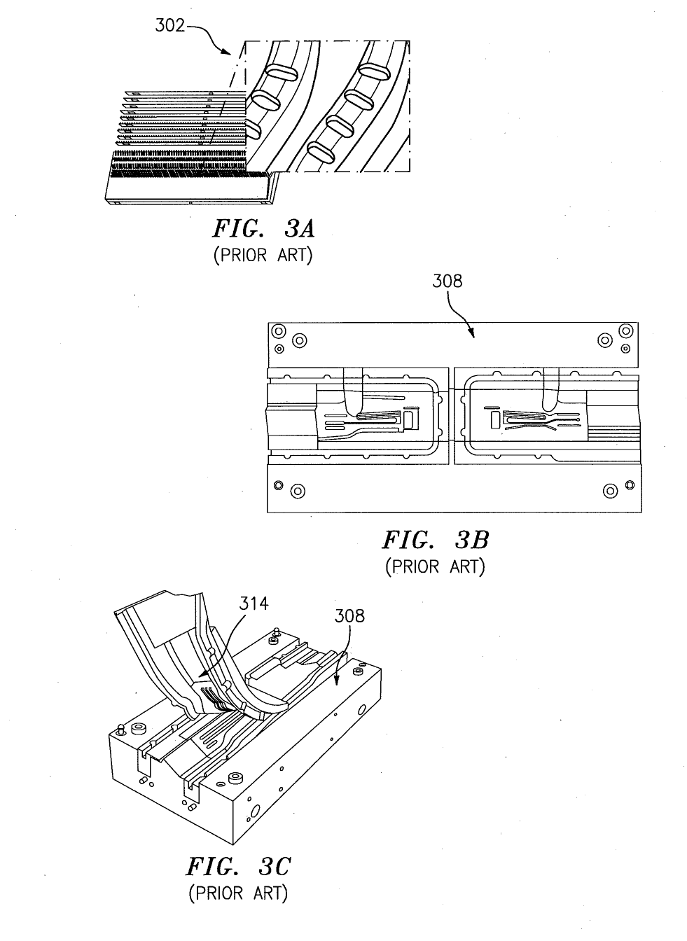

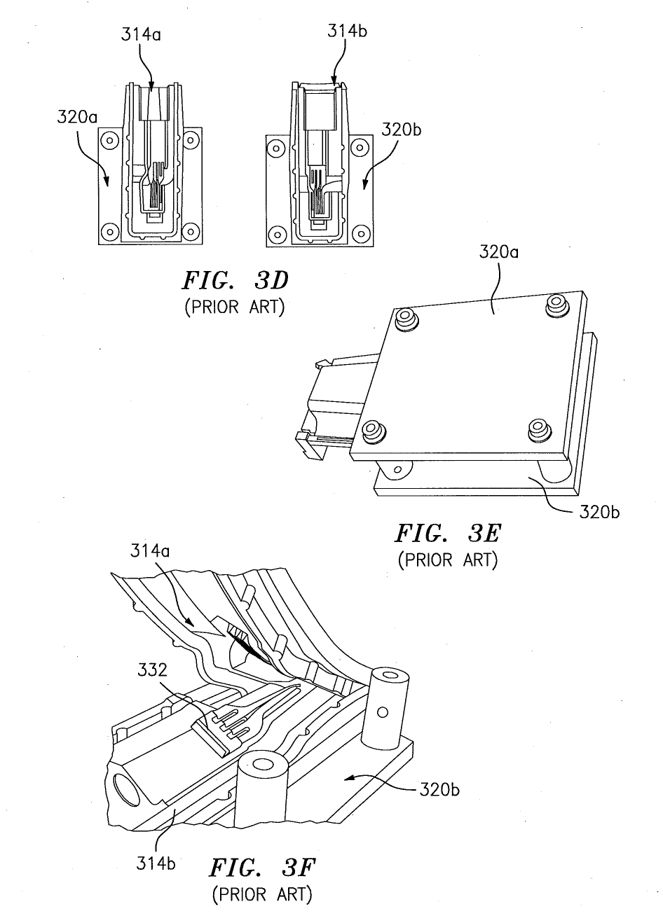

In block 210, the RMC 404 may be installed inside of a tool 408 (see FIG. 4B). In some embodiments, the tool 408 may include one or more of the structures/entities described above in relation to FIGS. 3A-3F. In some embodiments, the tool 408 may include one or more members (e.g., members 412a-412c) that may seat/position the RMC 404 at a particular location or orientation inside the tool 408. The members 412a-412c may include mechanical fasteners. In some embodiments, the members 412a-412c may be at least partially implemented as recesses/depressions formed in the tool 408. Other techniques for positioning the RMC 404 inside the tool 408 may be used as would be known to one of skill in the art.

In block 216, the tool 408 may be closed/sealed (as reflected in the transition from FIG. 4B to FIG. 4C in relation to wall members 408a and 408b of the tool 408). The closure/sealing provided as part of block 216 may serve to ensure that slurry that is added (as described below) does not escape from the tool 408. Block 216 may include the joining of plates in mated assembly as described above in relation to FIGS. 3D and 3E.

In block 222, a media/slurry 424 may be injected (e.g., poured) into the tool 408 to encapsulate at least a portion of the RMC 404 (see FIG. 4D). To assist with filling the tool with the poured slurry 424, a vacuum may be applied, pressure may be exerted to the media, the tool 408 may be agitated, or any combination of the foregoing techniques may be applied. The slurry 424 may include a first material 424a, such as for example a ceramic or metal material. In some embodiments, the slurry 424 may include a binder 424b. The binder 424b may include a polymer or wax resin. In some embodiments, the binder 424b may include a mixture of soluble wax and epoxy. In some embodiments, the binder 424b may include a ceramic binder, such as colloidal silica.

In block 228, the tool may be opened/unsealed and a composite body 430 formed from the combination of the slurry 424 and the RMC 404 may be removed from the tool 408 (see FIG. 4E). A threshold amount of time may be allowed to lapse between the execution of blocks 222 and 228 in order to allow the slurry 424 to harden/set and attach to the RMC 404.

In block 234, any binder 424b that is included in the composite body 430 may be removed to generate a binder-free composite body 430′ (see FIG. 4F—binder 424b shown as a hollow box to indicate removal). The binder 424b may be removed via an application of one or more chemicals (e.g., solvents, acids, etc.) or thermally by heating the binder. In some embodiments, a protective environment may be used as part of block 234 to avoid contaminating the RMC 404.

In block 240, the composite body 430′ may be sintered at a threshold temperature to impart strength to the composite body 430′.

Following execution of block 240, the (sintered) composite body 430′ may correspond to a positive of one or more features (e.g., holes) that may be formed in a component. In block 246, the (sintered) composite body 430′ may be installed into a wax injection die 442 (see FIG. 4G) to make wax patterns for subsequent casting.

In block 252, a casting technique may be performed to form one or more patterns, such as for example one or more wax patterns. In some embodiments, a die casting technique may be used. As reflected in FIG. 4H via the striping 448 (that is not shown in FIG. 4G), molten metal (e.g., nickel or a nickel alloy) may be injected into the die 442. The molten metal 448 may set/harden, where the composite body 430′ may correspond to the absence (e.g., negative) of metal 448. In this respect, the composite body 430′ may be used to form, e.g., holes/passages in the component due to this absence of the metal 448 in the area/region consumed by the composite body 430′ in the die 442.

The RMC 404 is shown in FIG. 4A in a simplified form/shape (namely, a rectangle) for the sake of ease in illustration. In some embodiments, the RMC 404 may be manufactured to include one or more attachment features to facilitate attachment of the slurry 424 to the RMC 404 (see, e.g., FIG. 4D and block 222 of FIG. 2).

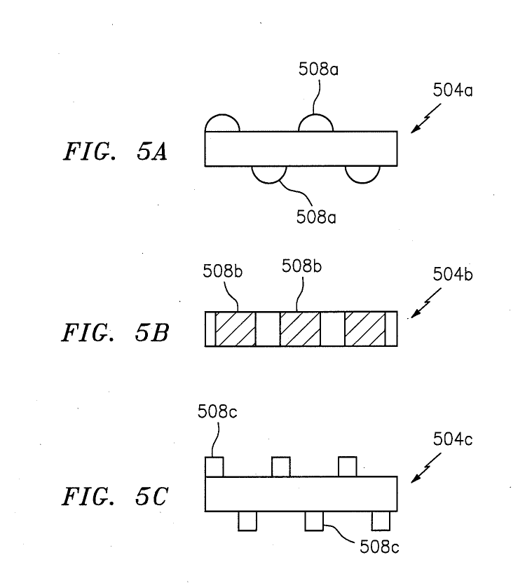

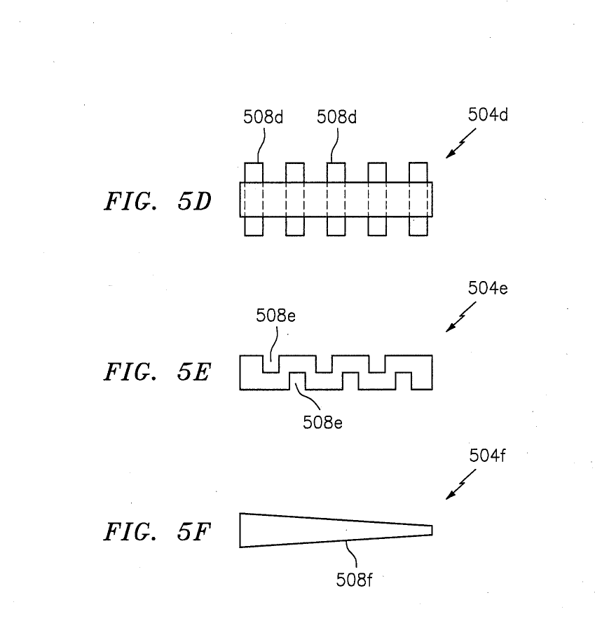

FIGS. 5A-5F illustrate various embodiments of attachment geometries that may anchor an RMC to a poured media/slurry when forming a component structure in connection with RMCs 504a-504f, respectively. One or more of the RMCs 504a-504f may correspond to the RMC 404.

The RMC 504a may include one or more semi-spherical bumps 508a. During application of the slurry 424, the slurry 424 may flow around the bumps 508a and set/harden in between adjacent bumps 508a.

The RMC 504b may include one or more slots/holes 508b. During application of the slurry 424, the slurry 424 may flow into the slots 508b and set/harden therein.

The RMC 504c may include one or more pins 508c. During application of the slurry 424, the slurry 424 may flow around the pins 508c and set/harden in between adjacent pins 508c.

The RMC 504d may include one or more through-pins 508d. During application of the slurry 424, the slurry 424 may flow around the through-pins 508d and set/harden in between adjacent through-pins 508d.

The RMC 504e may include one or more indentations/crevices 508e. During application of the slurry 424, the slurry 424 may flow into the indentations 508e and set/harden therein.

The RMC 504f may include a tapered edge/surface 508f. During application of the slurry 424, the edge 508f may present sufficient surface area to cause the slurry 424 to adhere to the RMC 504f.

The various attachment features 508a-508f of the RMCs 504a-504f described above may facilitate locking/joining the slurry 424 relative to the RMC. In the absence of such attachment features 508a-508f, the slurry 424 may be prone to separating from the RMC (e.g., the slurry 424 may not adhere to the RMC). The attachment features 508a-508f may assist in ensuring that two separate pieces of composite (e.g., the slurry 424 and the RMC) become a rigid composite body. The attachments features 508a-508f are illustrative; other types/form factors for the attachment features may be used in some embodiments.

Referring now to FIG. 2A, a method 200′ is shown. The method 200′ may incorporate many of the blocks/operations described above in connection with the method 200 of FIG. 2; e.g., the blocks 204′-252′ of FIG. 2A may correspond to their counterpart blocks 204-252 in FIG. 2. As such, a complete re-description of those blocks/operations is omitted herein for the sake of brevity. Also, while the methods 200 and 200′ are described separately herein for the sake of convenience, in some embodiments aspects of the methods 200 and 200′ may be incorporated together.

In block 256′, the pattern(s) of block 252′ may be assembled onto a fixture.

In block 262′, the fixture may be dipped into a media/slurry (e.g., a ceramic slurry) to create/generate a mold.

In block 268′, the mold may be allowed to dry.

In block 274′, wax may be removed from the mold.

In block 280′, the mold may be hardened by high-temperature firing.

In block 286′, metal may be melted and poured into the mold.

In block 292′, the metal may solidify. As part of block 292′, the mold may be removed.

In block 298′, a component/piece may be inspected. Any finishing techniques that are needed may be applied.

In some embodiments, one or more of the blocks of the method 200′ may be optional. The blocks may execute in an order/sequence that is different from what is shown in FIG. 2A. In some embodiments, additional blocks not shown may be included.

Aspects of the disclosure may provide design freedom to incorporate three-dimensional features in a component that cannot be made using conventional techniques. For example, the component may include, e.g., contours, tapers, or any other feature/passage/hole/ornamentation that may not have been available previously. The use of a RMC (potentially in combination with one or more ceramic cores) may enable multiwall components to be fabricated. Such components may provide enhanced cooling and weight savings relative to counterpart, conventional components.

While some of the examples described herein pertain to vanes and blades of an engine, aspects of the disclosure may be used to fabricate/manufacture other portions/components of the engine. Additionally, aspects of the disclosure may be used to fabricate components that may be used in other applications/environments, such as for example where intricate/complex cooling passages may be needed. For example, aspects of the disclosure may be used to fabricate components used in computers and phones.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional in accordance with aspects of the disclosure. One or more features described in connection with a first embodiment may be combined with one or more features of one or more additional embodiments.

What is claimed is:

1. A method comprising:
obtaining a refractory metal core (RMC);
installing the RMC inside a tool; and
subsequent to installing the RMC inside the tool, injecting a slurry into the tool to form a composite body from the RMC and the slurry.

2. The method of claim 1, further comprising:
removing the composite body from the tool; and
sintering the composite body subsequent to removing the composite body from the tool.

3. The method of claim 1, wherein the slurry includes a binder.

4. The method of claim 3, wherein the binder includes at least one of a mixture of soluble wax and epoxy or colloidal silica.

5. The method of claim 3, further comprising:
removing the binder from the composite body to obtain a binder-free composite body.

6. The method of claim 5, further comprising:
sintering the binder-free composite body.

7. The method of claim 5, wherein the removal of the binder is performed via an application of one or more chemicals.

8. The method of claim 5, wherein the removal of the binder is performed by heating the binder.

9. The method of claim 1, wherein the RMC includes at least one of molybdenum, tungsten, tantalum, or niobium.

10. The method of claim 1, further comprising:
fabricating the RMC using at least one of:
stamping,
laser cutting,
application of a photolithography technique, or
application of an additive manufacturing technique.

11. The method of claim 1, further comprising:
closing the tool prior to injecting the slurry into the tool.

12. The method of claim 11, wherein the tool includes a mold arranged as two halves, a first of the two halves secured to a first plate and a second of the two halves secured to a second plate, and wherein closing the tool includes joining the plates to one another in mated assembly.

13. The method of claim 1, further comprising:
installing the composite body into a die.

14. The method of claim 13, further comprising:
injecting molten material into the die to form a component,
wherein the composite body forms at least one of a hole or a passage in the component.

15. The method of claim 13, further comprising:
injecting molten material into the die to form at least one pattern;
assembling the at least one pattern onto a fixture;
dipping the fixture into a ceramic media to create a mold;
removing wax from inside of the mold;
melting metal and pouring the melted metal into the mold; and
removing the mold when the melted metal solidifies.

16. The method of claim 15, further comprising:
firing the mold prior to pouring the melted metal into the mold.

17. The method of claim 1, wherein the RMC includes at least one attachment feature for encapsulating and locking the slurry to the RMC.

18. The method of claim 17, wherein the at least one attachment feature includes at least one of:
a semi-spherical bump,
a slot,
a pin,
a through-pin,
an indentation, or
a tapered edge.

19. A composite body, comprising:
a refractory metal core (RMC); and 11 a slurry that at least partially encapsulates the RMC;

20. The composite body of claim 19, wherein the slurry includes at least one of a ceramic material or metal material, and wherein the slurry includes a binder, and wherein the RMC includes at least one attachment feature to lock the slurry to the RMC.
